(19) United States
(12) Patent Application Publication
(10) Pub. No.: US 2003/0006961 A1
(43) Pub. Date: Jan. 9, 2003

(54) Method and system for increasing computer operator's productivity

(76) Inventor: Yuly Shipilevsky, Toronto (CA)

Correspondence Address: YULY SHIPILEVSKY, APT. 404, 40 FOUNTAINHEAD ROAD, TORONTO, ON, M3J 2V1, CA

(21) Appl. No.: 10/179,261

(22) Filed: Jun. 26, 2002

Related U.S. Application Data
(60) Provisional application No. 60/303,995, filed on Jul. 9, 2001.

(51) Int. Cl. G09G 5/08

(52) U.S. Cl. 345/157

(57) ABSTRACT

A method and system for increasing computer operators' productivity in connection with the application which does not support multiple relative-pointing devices, over manipulating simultaneously and independently of at least two pointers on the same display screen of the computer by means of hands, feet, fingers of at least one computer operator over manipulating of the corresponding relative-pointing devices such as mice, trackballs or the like, coupled to the computer and associated with the corresponding pointers, wherein signals from the relative-pointing devices are being processed by shared cursor driver.

### BACKGROUND OF THE INVENTION

This invention relates generally to the methods and systems for increasing computer operator's productivity, and specifically to the methods and systems when a computer operator operates with relative-pointing devices(RPDs).

It is well known in the art to use RPD, such as trackball or a mouse, with a computer system. A computer system generally employs Graphical User Interface(GUI). A GUI relies heavily on RPD input, allowing the user to perform many functions by use of the RPD. To move a pointer, e.g., an arrow, a cursor, or an icon, displayed on a display, e.g., a Cathode Ray Tube or a Liquid Crystal Display, that serves as the output device of the computer, a mouse as a typical RPD is often use. There are different kinds of mice: mechanical, optical, wireless, gyro, feet-operated.

Manipulation of the RPD by operator's hands, feet, fingers issues pointer positioning signals to the computer system as deltas for X and Y. That signals, finally, received and translated by a special routine, known as a cursor driver the computer system uses to move the pointer at a new location on the display, at the location that corresponds to the mentioned above deltas (U.S. Pat. No. 6137472).

A common difficulty of the prior art is that prior methods and systems are not adapted for implementation of a large plurality of pointers at the same time and on the same display screen, the pointers, associated and corresponded with the appropriate RPD or RPDs, manipulated by operator's hands, feet, fingers wherein each RPD is coupled to the same computer system, operated by that operator.

Meanwhile, it is preferable to manipulate simultaneously of a plurality of pointers at the same time and on the same display screen using the RPDs, coupled, associated and communicating with the same computer system that comprises said display screen.

An excellent example, illustrating mentioned above preferences, demonstrate applications, comprising an onscreen keyboard. It is very easy and convenient to type symbols using onscreen keyboard by means of two independent pointers, each pointer is associated with it's own mouse, manipulated independently by the right and left operator's hands accordingly.

The increasing efficiency and convenience of modern ergonomic RPDs amplify mentioned above preferences.

U.S. Pat. Nos. 5,898,419 and 6,115,027 disclose computer systems connected together via a network, wherein pointers' images which are displayed at the remote computers are also displayed at the local computer.

The local computer's user just sees (but can not control and manipulate of) “pseudo” pointers (created and completely controlled and manipulated from the remote computers) in addition to his or her single own “true” pointer. That single own “true” pointer is associated, controlled and manipulated by that local computer's user via the RPDs coupled to his or her local computer.

### BRIEF SUMMARY OF THE INVENTION

The present invention provides effective method and system to increase computer system operator's productivity over providing the ability to manipulate of a large plurality of pointers at the same time and on the same display screen of his or her computer system.

According to the invention a multipointer manipulating system includes a computer system having a memory, a display screen, a processor and more than one relative-pointing devices (RPDS) coupled to the computer system.

Each pointer is controlled, manipulated and associated with one or more RPDs over the appropriate hands, feet, fingers. Each RPD is completely controlled, manipulated and associated with one hand or one foot or fingers.

The user is able independently manipulate of each pointer at the same time and on the same display screen using independently moving hands, feet, fingers, each one associated with the appropriate RPD.

The simplest embodiment of the multipointer manipulating system includes a computer system having a memory, a display screen, a processor and a couple of mice, each coupled to the computer system. The user is able to manipulate of two different pointers at the same time and on the same display screen. The first pointer is associated and controlled by the first mouse and the second pointer is associated and controlled by the second mouse, each mouse is manipulated independently by the appropriate user's hand.

### BRIEF DESCRIPTION OF THE SEVERAL VIEWS OF THE DRAWING

FIG. 1 is a general view of a multipointer manipulating system (MMS) according to a preferred embodiment of the present invention.

FIG. 2 is a diagrammatic view of the MMS according to a preferred embodiment of the present invention.

### DETAILED DESCRIPTION OF THE INVENTION

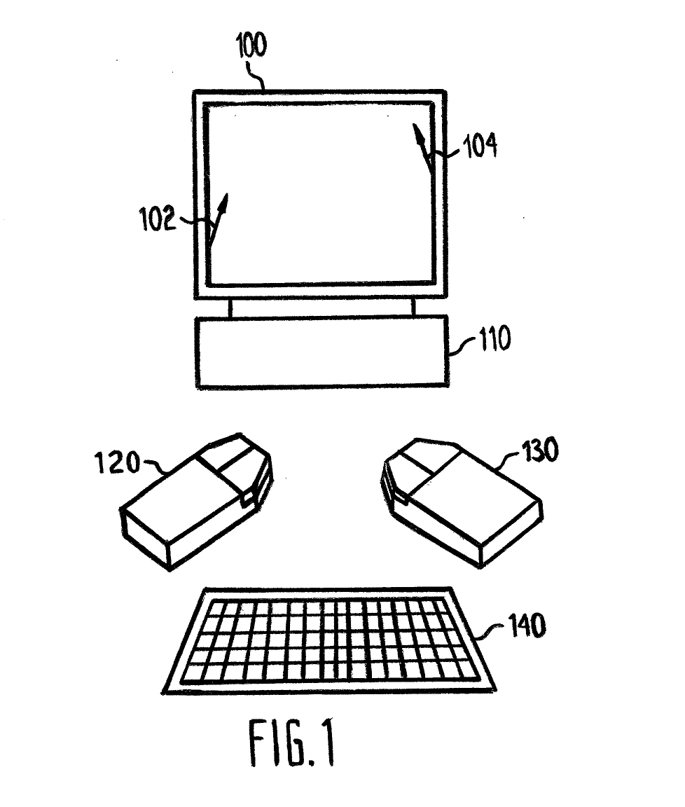

FIG. 1 is a general view of the MMS according to a preferred embodiment of the present invention. The MMS includes a display screen 100 with pointers 102 and 104, and a system device 110 coupled to the first mouse 120 and to the second mouse 130. The MMS may include as well keyboard 140, printers, etc.

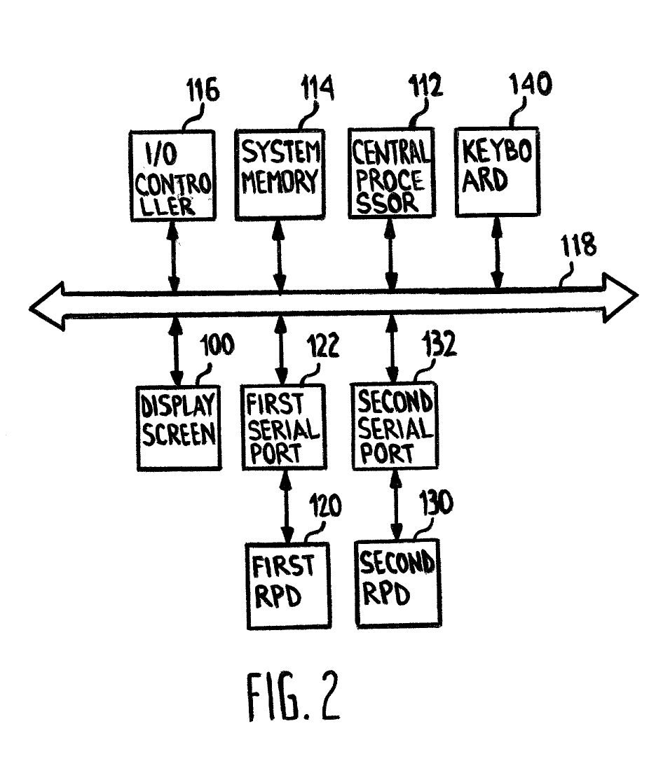

FIG. 2 is a diagrammatic view of the MMS according to a preferred embodiment of the present invention.

Reffering to the FIG. 1 and FIG. 2, the system device 110 includes a central processor 112, a system memory 114, 1/0 controller 116, a communications port 122 for communications to the first mouse 120, a communications port 132 for communications to the second mouse 130 and a system bus 118 couples the components of the MMS, providing a link between them. The system device 110 may include as well an external interface, a fixed disk, etc.

The MMS is used to increase computer operator's productivity over providing a possibility for the operator to manipulate independently of two pointers 102 and 104, at the same time and on the same display screen 100. Manipulations of first pointer 102 are implemented over manipulations of first mouse 120 coupled to the system device 110, and manipulations of second pointer 104 are implemented over manipulations of second mouse 130 coupled to the same system device 110. Manipulations of first mouse 120 are produced by means of first operator's hand and manipulations of second mouse 130 are produced by means of second operator's hand. First mouse 120 is coupled to the system device 110 via communications port 122 and second mouse 130 is coupled to the system device 110 via communications port 132. Manipulation of first mouse 120 issues first pointer 102 positioning signals and manipulation of second mouse 130 issues second pointer 104 positioning signals. The signals from both mice 120 and 130 are sent to communications hardware(e.g., serial I/O ports): the signals from mouse 120 is sent to communications port 122 and the signals from mouse 130 is sent to communicatons port 132. A special routine, known as a cursor driver is shared between communications ports 122 and 132. Upon signals receiving from mouse 120, communications port 122 interrupts execution of any program processed by central processing unit and passes control to the cursor driver, shared between mice 120 and 130 and their communications ports 122 and 132 accordingly. Shared cursor driver receives the signals from communications port 122, translates them into signals the computer system uses to present the pointer 102 a new location and returns control to the interrupted program. Upon signals receiving from mouse 130, communications port 132 interrupts execution of any program processed by central processing unit and passes control to the shared cursor driver. Cursor driver receives the signals from communications port 132, translates them into signals the computer system uses to present the pointer 104 a new locaton and returns control to the interrupted program.

Thus, the same operator can simultaneously manipulate of two different pointers, each one independently movable on the same display screen.

A person understanding this invention may now conceive of alternative structures and embodiments or variations of the above without departing from the spirit and scope of the invention. All thus which fall within the scope of the claims appended hereto are considered to be part of present invention.

The description is there to be regarded as illustrative instead of restrictive on the present invention. Furthermore, in the description and the drawings, the system has only two RPDs and two ports for manipulating of two pointers by one operator. Those skill in the art will understand that this is so solely to simplify the description and that such computer system may use any number of RPDs and ports for manipulating of any number of pointers by any number of operators simultaneously.

I claim:

1. A computer system for use simultaneously by at least one computer operator in connection with the application which does not support multiple relative-pointing devices, said computer system comprising: a computer having a memory, a display, a processor, a keyboard and relative-pointing devices such as mice, trackballs or the like, said relative-pointing devices are coupled to said computer via their input circuits, said relative-pointing devices are producing pointer positioning signals to position at least two pointers at the same time and on the same said display, said signals are processed by shared cursor driver, said shared cursor driver is stored in said memory of said computer, said shared cursor driver is stored in said memory of said computer, said shared cursor driver is shared between said relative-pointing devices, each said pointer is controlled by at least one of said relative-pointing devices, each said relative-pointing device is manipulated of at least one of said computer operator.

2. The computer system as clamed in claim 1, wherein each said relative-pointing device is coupled to the different port of said computer system.

3. The computer system as clamed in claim 1, wherein said relative-pointing devices are coupled to said computer system via Universal Serial Bus(USB).

4. The computer system as clamed in claim 1, wherein at least one said relative-pointing device is cordless.

5. The computer system as clamed in claim 1, wherein at least one said relative-pointing device comprises an optical movement-detection circuit.

6. The computer system as clamed in claim 1, wherein at least one said relative-pointing device comprises an infrared communications circuit.

7. The computer system as clamed in claim 1, wherein at least one said relative-pointing device comprises radio frequency communications circuit.

8. A method to increase computer operators' productivity over providing a computer system for use simultaneously by at least one computer operator in connection with the application which does not support multiple relative-pointing devices, said computer system comprising: a computer having a memory, a display, a processor, a keyboard and relative-pointing devices such as mice, trackballs or the like, said relative-pointing devices are coupled to said computer via their input circuits, said relative-pointing devices are producing pointer positioning signals to position at least two pointers at the same time and on the same said display, said signals are processed by shared cursor driver, said shared cursor driver is stored in said memory of said computer, said shared cursor driver is shared between said relative-pointing devices, each said pointer is controlled by at least one of said relative-pointing devices, each said relative-pointing device is manipulated of at least one of said computer operator, the method comprising the following steps:
(a) providing of mounted said computer system;
(b) manipulating simultaneously of at least two said pointers on the same said display, each said pointer is controlled, associated and manipulated by means of at least one of said operators' extremities via and by means of the corresponding said relative-pointing devices.

9. The method as clamed in claim 8, wherein at least one of said relative-pointing devices is manipulated of a palm of at least one of said operators.

10. The method as clamed in claim 8, wherein at least one of said relative-pointing devices is manipulated of at least one foot of at least one of said operators.

11. The method as clamed in claim 8, wherein at least one of said relative-pointing devices is manipulated of at least one finger of at least one of said operators.

12. The method as clamed in claim 8, wherein said application includes an onscreen keyboard and wherein said method is applied for typing using said onscreen keyboard.

13. The method as clamed in claim 8, wherein each said relative-pointing device is coupled to the different port of said computer system.

14. The method as clamed in claim 8, wherein said relative-pointing devices are coupled to said computer system via Universal Serial Bus(USB).

15. The method as clamed in claim 8, wherein at least one said relative-pointing device is cordless.

16. The method as clamed in claim 8, wherein at least one said relative-pointing device comprises an optical movement-detection circuit.

17. The method as clamed in claim 8, wherein at least one said relative-pointing device comprises an infrared communications circuit.

18. The method as clamed in claim 8, wherein at least one said relative-pointing device comprises radio frequency communications circuit.
